(19) United States
(12) Patent Application Publication
(10) Pub. No.: US 2026/0210814 A1
(43) Pub. Date: Jul. 23, 2026

(54) REFERENCE GRID ASSEMBLY FOR USE IN EXPANSION MICROSCOPY

(71) Applicant: UNIVERSITEIT UTRECHT HOLDING B.V., Utrecht (NL)

(72) Inventors: Hugo Geert Jan DAMSTRA, Utrecht (NL); Josiah Benjamin PASSMORE, Utrecht (NL); Wilco NIJENHUIS, Utrecht (NL); Lukas KAPITEIN, Utrecht (NL)

(21) Appl. No.: 19/139,617

(22) PCT Filed: Dec. 15, 2023
(86) PCT No.: PCT/EP2023/086131

§ 371 Date: Jun. 16, 2025

(30) Foreign Application Priority Data
Dec. 16, 2022 (NL) 2033740

(51) Int. Cl. G01N 1/28; G01N 1/34; G02B 21/34; G02B 27/58

(52) U.S. Cl. CPC G01N 1/2813; G01N 1/34; G02B 21/34; G02B 27/58; G01N 2001/282

(57) ABSTRACT

The present invention relates to a reference grid assembly for use in expansion microscopy (ExM) of a biological sample providing a scalable and expandible calibration marker for ExM. The present invention further relates to methods for analyzing a biological sample by expansion microscopy using the reference grid assembly and the use of the reference grid assembly in expansion microscopy of a biological sample.

### DESCRIPTION

The present invention relates to a reference grid assembly for use in expansion microscopy (ExM) of a biological sample providing a scalable and expandible calibration marker for ExM. The present invention further relates to methods for analyzing a biological sample by expansion microscopy using the reference grid assembly and the use of the reference grid assembly in expansion microscopy of a biological sample.

Expansion microscopy (ExM) is a powerful technique to overcome the diffraction limit of light microscopy by physically expanding biological specimen isotropically in three dimensions (3D). ExM can be used to directly expand, and visualize with nanoscopic resolution, cells, intact tissues, and human biopsy samples, providing new opportunities for cell biology and pathology. In ExM the effective resolution of light microscopy is increased by physical expansion of cells and tissues. Biological specimens are anchored to a swellable hydrogel, typically by conjugation of an acrylate group to free lysines and subsequent polymerization of an acrylamide gel that includes sodium acrylate. Next, the sample is chemically homogenized to detach the gel from the culturing substrate and prevent resistance during expansion. Finally, addition of water induces four-to ten-fold swelling in all dimensions. Since ExM can be used to directly expand cells and intact tissues, ExM has quickly become an important technique in biological research that also has great potential for diagnostic purposes in the clinic.

However, during expansion of the biological sample (local) deformation of the biological sample and differences in expansion factor occur, which are difficult to standardize or accurately determine. Quantitative interpretation of expanded samples relies on robust characterization of expansion fidelity, which could be compromised by local anisotropy in expansion due to differences in gel composition, density, or sample preparation. A broad scale adoption of ExM for clinical and diagnostic applications is hampered by the absence of robust quality control mechanisms for expansion factor determination and deformation mapping. In recent years, various specialized ExM variants have been described focusing on improving preservation of specific structures, expanding tissues and entire organisms, including human biopsy tissues, and combinations with other super-resolution modalities. Furthermore, since the effective resolution of ExM is in part limited by the expansion factor, there has been a push to develop higher expanding methods compared to the original ExM method either by varying the crosslinking concentration, using alternative crosslink chemistry, or using iterative approaches. For biological reproducibility, quantitative accuracy, and diagnostic and pathology applications, a broadly applicable quality control mechanism that enables robust and reproducible characterization of the exact expansion factor and of possible local deformations is essential.

In most cases, the expansion factor is determined macroscopically by measuring the size of the expanded gel, although how this relates to the nanoscopic expansion factor is unclear. Current attempts to directly measure the microscopic expansion factor are not compatible with biological samples and do not provide information about local deformations. Often, ExM variants are validated for expansion factor and deformation using cellular reference structures, such as nuclear pore complexes (NPCs) or clathrin coated pits (CCPs) that have a distinct size known from other modalities such as electron microscopy. The precise local expansion factor can be determined by correlating a reference structure, e.g., a stained cell, before expansion to the same structure after expansion. This is a powerful approach as it can also be used to map local deformations that occur during expansion and sample mounting. However, due to the physical differences between pre-and post-expanded samples, robust correlation is time consuming, laborious, relies on efficient sample navigation and efficient labelling of the structure of interest, and is low throughput-making it hard to assess reproducibility and variability in terms of expansion and deformation of multiple gels and samples. Easy to use reference-free quality control mechanisms are currently lacking, which significantly hampers widescale adoption of ExM for quantitative purposes, including clinical or diagnostic applications.

Considering the above, there is a need in the art for a robust, quick, widely adoptable, and easy quality control application for expansion factor determination and deformation mapping to be used in ExM for clinical and diagnostic applications providing improved biological reproducibility, and quantitative accuracy.

It is an object of the present invention, amongst other objects, to address the above need in the art. The object of present invention, amongst other objects, is met by the present invention as outlined in the appended claims.

Specifically, the above object, amongst other objects, is met, according to a first aspect, by the present invention by a reference grid assembly for use in expansion microscopy (ExM) of a biological sample, wherein the reference grid assembly comprises an expandible hydrogel or a substrate suitable for cell culture, wherein said hydrogel or substrate comprises a micropattern comprising micropatterned photoreactive or photoactivatable organic molecules or peptides providing a scalable and expandible calibration marker for ExM. The reference grid assembly of the present invention is comprised of a transferable protein-based micro-patterned grid, that serves as a fluorescent molecular marker or a ruler, which is incorporated in the hydrogel simultaneously with the biological specimen for intrinsic calibration of hydrogel-embedded samples. The micropattern can also be provided onto a culture substrate, such as a coverslip, on which then cell culture is possible, i.e., on top of the micropatterned coverslip (providing a scalable and expandible calibration marker), wherein both cells and the micropattern as a calibration marker can be transferred simultaneously to a hydrogel for subsequent use in ExM applications. Experiments demonstrate that this grid can be used to precisely determine the local expansion factor and to correct for deformations without the use of cellular reference structures or pre-expansion ground truth images. The reference grid of present invention can aid sample navigation for correlative uses of expansion microscopy. The patterned reference grid is compatible with expansion of tissue and can be readily adopted as a critical quality control step in existing ExM applications or sample processing pipelines. The reference grid of present invention introduces a fluorescent coordinate system into the hydrogel that functions as an expandible ruler that accurately reports (local) expansion factors, enables reference-free deformation mapping, and also facilitates sample navigation.

Protein micropatterning is used in biological research as a tool to influence cell morphology in order to alter the orientation of the cell division axis, organelle positioning and cytoskeleton rearrangement. In one embodiment of the current invention, photolithography is used to control the geometry and dimensions of the micropatterned grid on the micrometre scale to map deformations and expansion factor on the cellular scale. The local nanoscopic expansion factor is robustly quantified because the reference grid assembly of the present invention functions as a scalable fiducial marker that is incorporated in the hydrogel used in ExM. The marker consists of a repeating pattern providing a grid of known dimensions. In case local deformations occur during expansion, this is reflected in a visibly distorted grid that can be used for correction without relying on a pre-expanded reference state.

According to a preferred embodiment, the present invention relates to the reference grid assembly, wherein the micropatterned photoreactive or photoactivatable organic molecules or peptides are engineered peptides comprising one or more sites for fluorophore labelling and/or acrylate modification. Acrylate modifications may be used to incorporate the micropatterned photoreactive or photoactivatable organic molecules or peptides into the hydrogel. In ExM, biological specimen are post-fixed using acryloyl-X SE that covalently attaches a acrylate group to free lysines. Alternatives include direct crosslinking to acrylamide using aldehyde-type fixation.

According to another preferred embodiment, the present invention relates to the reference grid assembly, wherein the micropattern is comprised of a continuous repeated pattern.

According to another preferred embodiment, the present invention relates to the reference grid assembly, wherein the micropattern is comprised of a continuous repeated square pattern, preferably wherein the square pattern is comprised of squares having a size of 250×250 nm to 250x250 μm, preferably 500×500 nm to 100×100 μm, more preferably 1×1 μm to 50×50 μm, most preferably 10×10 μm to 30×30 μm. The smaller the scale of the reference grid micropattern, the more accurate deformations can be corrected for in ExM and the more accurate deformations are reflected in the reference grid.

According to yet another preferred embodiment, the present invention relates to the reference grid assembly, wherein the micropattern is furthermore comprised of one or more different micropattern designs, such as letters, numbers or geometric shapes, having a size in length of about 1 to 400 μm, preferably 5 to 250 μm, more preferably 10 to 100 μm. Such different micro pattern designs may function as further navigational markers of the reference grid.

According to another preferred embodiment, the present invention relates to the reference grid assembly, wherein the micropatterned photoreactive or photoactivatable organic molecules or peptides are one or more selected from the group consisting of photoreactive or photoactivatable labeled matrix proteins such laminin, fibrinogen, and labeled nanobodies, exogenous orthologous protein, such as nonreactive nanobody, preferably photoreactive or photoactivatable labelled nanobodies. The micropatterned photoreactive or photoactivatable proteins are preferably laminin and/or fibrinogen covalently linked to either a fluorescent protein, or a fluorescent dye. Furthermore, also nanobodies may be used that are single-domain antibody, i.e., an antibody fragment comprised of a peptide chain of about 100 to 150 amino acids long, comprised of a monomeric variable antibody domain that is able to bind selectively to a specific antigen.

According to yet another preferred embodiment, the present invention relates to the reference grid assembly, wherein the micropatterned photoreactive or photoactivatable organic molecules or peptides are conjugated with a photoreactive or photoactivatable agent selected from the group consisting of a fluorophore such as a photoactivatable fluorophore, a photoactivatable rhodamine, such as NVOC2-Q-rhodamine, fluorescent dye, photo-convertible fluorescent group, photoactivatable synthetic fluorophore or fluorescent protein, preferably a photoactivatable fluorophore or photoactivatable rhodamine. The micropatterned photoreactive or photoactivatable organic molecules or peptides are homogenously and covalently conjugated to the hydrogel during gelation. A two-or three-dimensional micropattern can be produced directly in the polymerized hydrogel using patterned illumination either in a scanning laser setup, a locally targeted laser or LED, a digital micromirror device, or by multi-photon excitation.

According to another preferred embodiment, the present invention relates to the reference grid assembly, wherein the micropatterned photoreactive or photoactivatable organic molecules or peptides are biologically inert with respect to the biological sample to be used in ExM. The reference grid is biologically inert to ensure biological reproducibility and compatibility with all cell types. Cells may grow on top of the reference grid pattern and hampered by the proteins underneath, the cells are not affected by the pattern.

According to yet another preferred embodiment, the present invention relates to the reference grid assembly, wherein the micropatterned photoreactive or photoactivatable organic molecules or peptides are furthermore labelled by fluorescent antibodies or fluorescent dyes, for example using direct or indirect immunofluorescence against the organic molecule or peptide, or modification of the organic molecule or peptide with a self-labelling tag such as SNAP-tags or HaloTag. To further increase the photoreactive or photoactivatable signal during ExM, the proteins making up the reference grid can be further amplified by using fluorescent antibodies. The further labeling is preferably in a different color than the initial micropatterned photoreactive (or photoactivatable) reference grid, but may also be the same color for signal amplification.

According to a preferred embodiment, the present invention relates to the reference grid assembly wherein the culturing substrate is preferably a coverslip, preferably a glass, polyacrylamide, or polydimethylsiloxane coverslip. The reference grid may also be provided onto other similar culturing substrates e.g., well plates, culturing flasks, glass or plastic bottom chamber slides, silicone filter material, etc.

According to a preferred embodiment, the present invention relates to the reference grid assembly, wherein said substrate is furthermore comprised of a top coating comprised of poly-L-lysine, poly-D-lysine, or extracellular matrix protein such as laminin or fibrinogen. The top coating is sometimes preferred as some cell types such as neurons require a specific coating to adhere to the substrate. Therefore, after micropatterning of the substrate a specific coating is provided on top to facilitate cell adherence. Preferably the substrate is coated with a cell type specific topcoat, comprised of for example poly-L-lysine, poly-D-lysine, extracellular matrix protein such as laminin or fibrinogen, antibodies necessary for biological function, collagen or Matrigel, including the use of three-dimensional cell culture.

The present invention, according to a second aspect, relates to a method for analyzing a biological sample by expansion microscopy (ExM) using a reference grid assembly as disclosed herein, comprising the steps of,
a) providing a substrate suitable for cell culture, such as a cover slip, that is micropatterned with photoreactive or photoactivatable organic molecules or peptides, thereby providing a reference grid to said substrate,
b) contacting the biological sample, such as tissue or cells, with the substrate thereby providing the biological sample with the reference grid,
c) transfer of the biological sample comprising the reference grid to an unpolymerized hydrogel solution suitable for ExM, followed by polymerization of the hydrogel including the biological sample and the reference grid,
d) expansion of the polymerized hydrogel including the biological sample and reference grid by addition of an aqueous solution to the polymerized hydrogel,
e) observing the expanded biological sample under a microscope.
   To increase the compatibility with known ExM chemistry, the reference grid can be used in cell culture by use of a substrate, and is also transferable from substrate culture surface to hydrogel, such that it can also be incorporated or embedded into the hydrogel simultaneously with the biological sample, such as cells or tissue. The reference grid of the present invention can be directly used as a culturing substrate or be incorporated into the gel during sample preparation. The method of present invention makes use of an embedded reference grid to intrinsically calibrate hydrogels. This grid functions as an expandible ruler that accurately reports (local) expansion factors, enables reference-free deformation mapping and also facilitates sample navigation.

The present invention, according to a further aspect, relates to a method for analyzing a biological sample by expansion microscopy (ExM) using a reference grid assembly as disclosed herein, comprising the steps of,
a) providing a biological sample in an unpolymerized hydrogel solution suitable for ExM comprised of photoreactive or photoactivatable organic molecules or peptides that can be micropatterned, followed by polymerization of the hydrogel including the biological sample,
b) micropatterning of the photoreactive or photoactivatable organic molecules or peptides in said polymerized hydrogel, thereby providing a reference grid in the (unexpanded) hydrogel
c) expansion of the polymerized hydrogel including the biological sample and reference grid, by addition of an aqueous solution to the polymerized hydrogel,
d) observing the expanded biological sample under a microscope.

According to a preferred embodiment, the present invention relates to the methods as disclosed above wherein the method further comprises the step of f) or e), respectively; quantitative interpretation of the expanded biological sample by determination of the expansion factor and deformation mapping using the reference grid.

According to another preferred embodiment, the present invention relates to the method, wherein the method furthermore comprises the step of contacting the micropatterned photoreactive or photoactivatable proteins with fluorescent antibodies providing further signal amplification of the micropatterned photoreactive or photoactivatable proteins. After the cells grow on the substrate cells can be fixated and immunofluorescence staining including grid amplification can be performed. Furthermore, immunofluorescence staining including grid amplification can be performed after hydrogel polymerization including the biological sample including reference grid.

According to a preferred embodiment, the present invention relates to the method, wherein micropatterning is done using deep-UV, by laser microcontact printing, or etching, for example protein photolithography with deep-UV. By deep-UV photolithography, ultraviolet light is used to transfer the geometrical design (for example the numbers and letters) of the optical mask (or photomask) to the UV light-sensitive chemical coated (i.e. the fluorescent protein) on the culture substrate (i.e. coverslip) to produce the micropatterned coverslips. Using protein photolithography to pattern proteins different grid designs, patterned proteins or fluorescent groups can be incorporated into the expansion hydrogel together with the biological specimen in an approach compatible with all current ExM variants. Importantly, the reference grid of present invention solves the challenge of sample navigation in ExM by directly incorporating a fluorescent coordinate system into the ExM hydrogel. This facilitates experiments in which imaging with other modalities is followed up by ExM. The use of the reference grid of present invention in ExM provides an essential quality control step that is directly compatible with all current ExM chemistries for easy adoption in current ExM workflows.

According to another preferred embodiment, the present invention relates to the method, wherein the culturing substrate comprised of the reference grid is sterilized before application of the biological sample on said culturing substrate. Sterilization reduces the chance of microbial infection of the biological sample.

According to yet another preferred embodiment, the present invention relates to the method, wherein the substrate is a coverslip, preferably a glass, polyacrylamide or polydimethylsiloxane coverslip and/or wherein said substrate is furthermore provided with a topcoat, wherein the topcoat is comprised of poly-L-lysine, poly-D-lysine, extracellular matrix protein such as laminin or fibrinogen.

The present invention, according to a further aspect, relates to use of a reference grid as disclosed herein in expansion microscopy (ExM) for research, clinical and/or diagnostic purposes of a biological sample. Correction of local deformation, scaling and/or expansion factor observed in the sample can be performed using the reference grid as a scalable ruler. The reference grid of present invention can be used for sample navigation, which for example aids correlation between pre-and post-expanded states. Apart from its use in view of the above biological and diagnostic uses, also non-biological uses may be envisioned using the reference grid assembly of present invention to validate differences in expansion recipes, measurement of expansion factor in iterative approaches, deformation from different sample mountings, etc, including non-biological uses in other fields such as material sciences.

The present invention will be further detailed in the following examples and figures wherein:

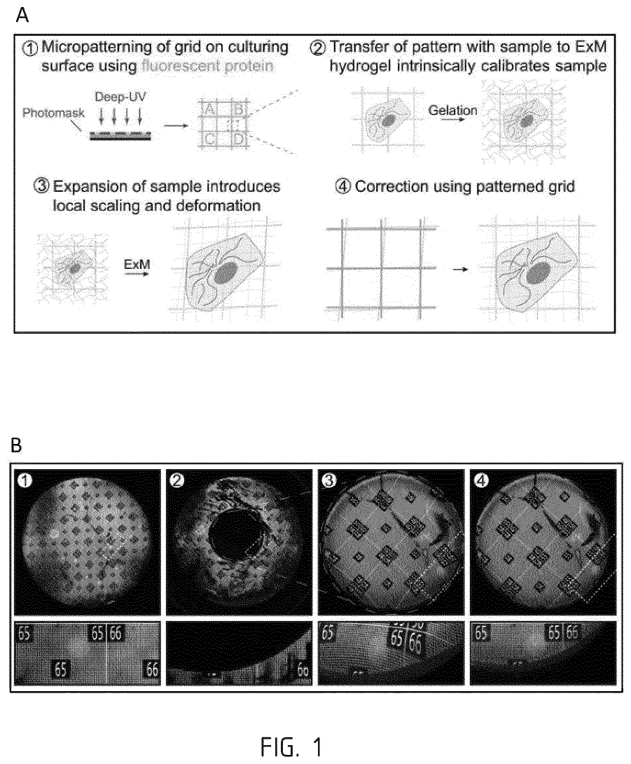

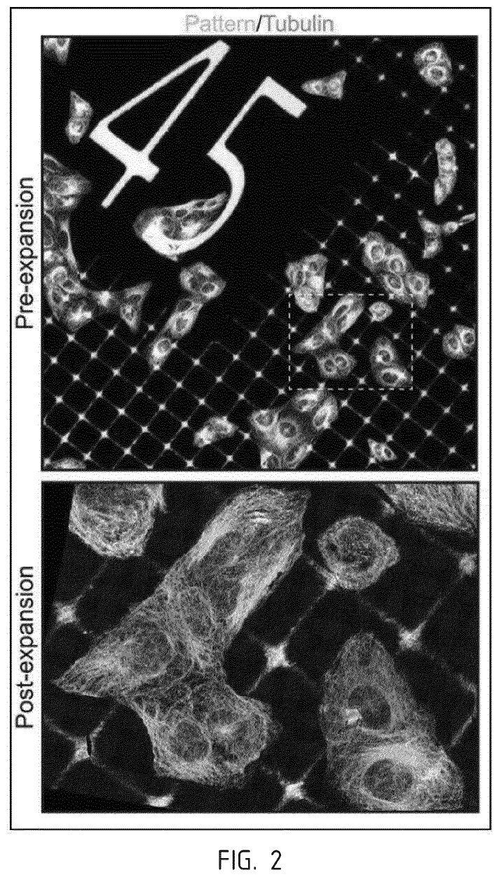

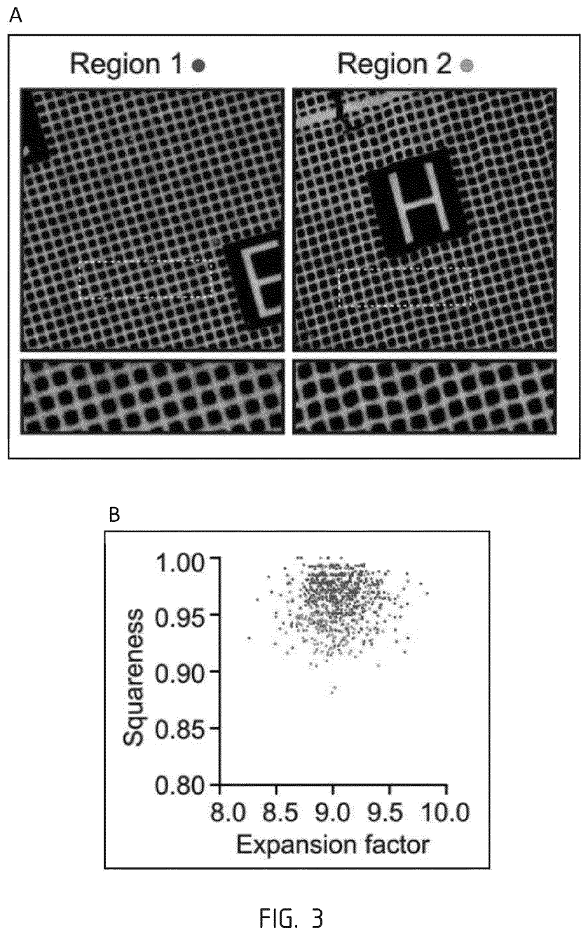

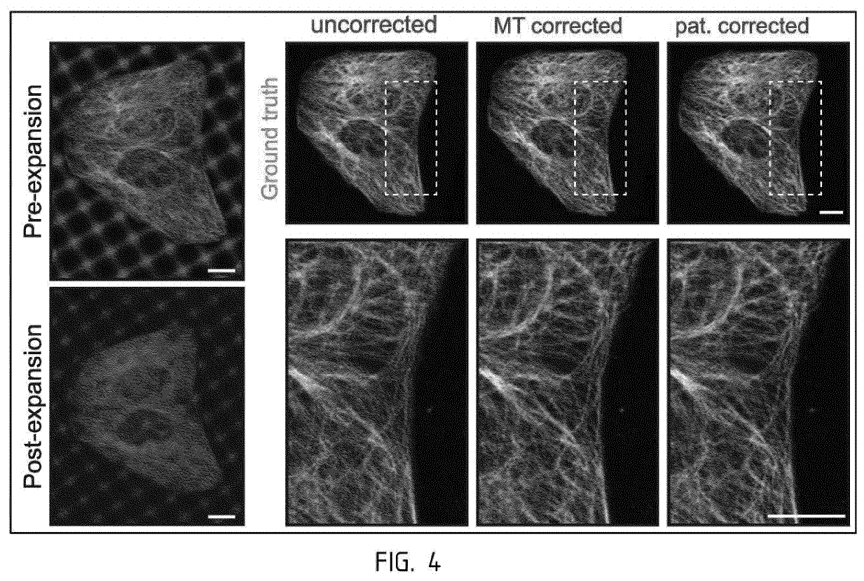

FIG. 1: FIG. 1A shows the schematic steps 1 to 4 of obtaining the reference grid of present invention according to a method of the present invention. FIG. 1B shows the corresponding microscopy images during step 1 to 4, FIGS. 1B, 1 to 1B, 4. Step 1 is the micropatterning, by for example protein photolithography with deep-UV, of a reference grid on a substrate, such as a cover slip, using fluorescent labelled protein. More specifically a glass coverslip patterned with fluorescent laminin and amplified with antibody labelling (orange) is shown before gelation of the hydrogel. The biological sample, such as cells, can be cultured on top of the cover slip comprising the reference grid of the present invention. FIGS. 1B, 1 shows the patterned fluorescently labelled protein on a glass coverslip in a repeating grid.
Step 2 is the transfer of the reference grid together with the biological sample to the hydrogel for ExM, followed by gelation of the hydrogel including the sample and the reference grid. FIGS. 1B, 2 shows the transfer of the patterned grid from the culture surface, demonstrating that the pattern is entirely incorporated into the ExM hydrogel and not left on the coverslip.
Step 3 is the expansion of the hydrogel (including the sample and reference grid) which introduces local scaling and deformation and shown in FIGS. 1B, 3. The expanded sample is then used in expansion microscopy (ExM) for analysis of the biological sample.
Step 4 is the correction of the local deformation and scaling using the reference grid of present invention acting as a scalable ruler. The reference grid provides an easy tool for robust quality control and expansion factor determination and deformation mapping in ExM, as shown in FIGS. 1B, 4.

FIG. 2: FIG. 2 shows U2OS cells stained for tubulin (cyan) cultured directly on a fluorescent laminin-patterned (orange, amplified with antibody labelling) glass coverslip as substrate, wherein the micropattern is comprised of a continuous repeated square pattern including a further micropattern designs, i.e. numbers (also orange). Upper panel shows the pre-expanded state and lower panel shows the same region after incorporation in the hydrogel and subsequent expansion, i.e. in the post-expanded state and corrected using the reference grid of present invention.

FIG. 3: FIG. 3A shows that the grid assembly of present invention amplified by staining and expanded reveals local anisotropies in ExM. Two representative regions of expanded patterned grids (20 μm squares) with deformations. These examples underscore the need for the present invention regarding quality control and reproducibility. FIG. 3B shows the quantification of the variability in local true expansion factor for regions indicated in FIG. 3A. A range in expansion factors was observed in regions of the same gel reaching up to 1×. A comparison of the deformation of each region with the local expansion factor revealed that while the spread in expansion factor is similar between samples from the same gel, the spread in deformation can vary substantially likely due to differences in sample mounting. Together, these results underscore the need for the present invention regarding quality control and reproducibility. Scale bars: FIG. 3A: 100 μm, zoomed regions 40 μm.

FIG. 4: Shows that the present invention can be used to correct for local expansion anisotropy. U2OS cells were grown on non-reactive nanobody reference grids of 10×10 μm, fixed and stained for tubulin, and imaged before and after expansion (left panels). By computationally overlaying the pre-and post-expansion tubulin images using a landmark-based registration the total deformations that occurred during expansion can be determined (compare ground truth (pre-expanded image) with uncorrected expanded image), which can be corrected using non-linear transformation of the post-expansion image as seen by an increased colocalization of the MT (tubulin) corrected (magenta) and ground truth (cyan) image. By correcting the deformations using the reference grid instead of the tubulin channel a qualitatively comparable image can be obtained (compare similarity between pattern corrected and MT corrected, in contrast to the uncorrected expanded image). Scale bars 10 μm.

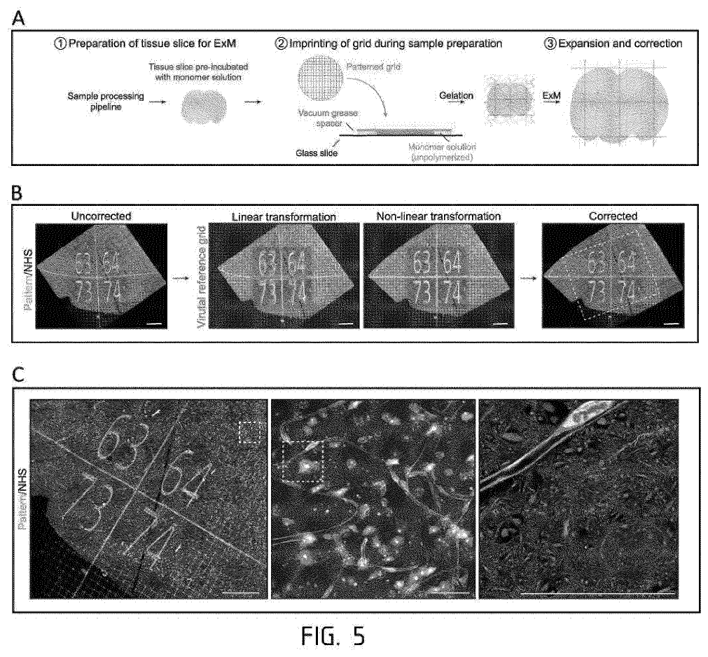

FIG. 5: FIG. 5A shows the schematic method of present invention providing a reference grid of micropatterned proteins provided or imprinted with the expanded tissue slices and used for correction in ExM. FIG. 5B shows the region of dissected mouse brain tissue (cortex) expanded for ExM, and stained for total protein (gray) and reference grid micropattern (orange) and imaged by confocal microscopy. The pattern channel was registered to a virtual reference grid (green) to correct for deformation (middle two panels and right panel). The resulting non-linear transformed protein channel was used for subsequent visualization of corrected tissue organization. FIG. 5C shows the use of the reference grid of present invention to bridge scales of tissue vasculature organization at high resolution zooms of blood vessel with surrounding tissue. Zoomed regions are indicated with white boxes. Scale bars: FIG. 5B: 200 μm, FIG. 5C: 200 μm (left), 20 μm (middle and right).

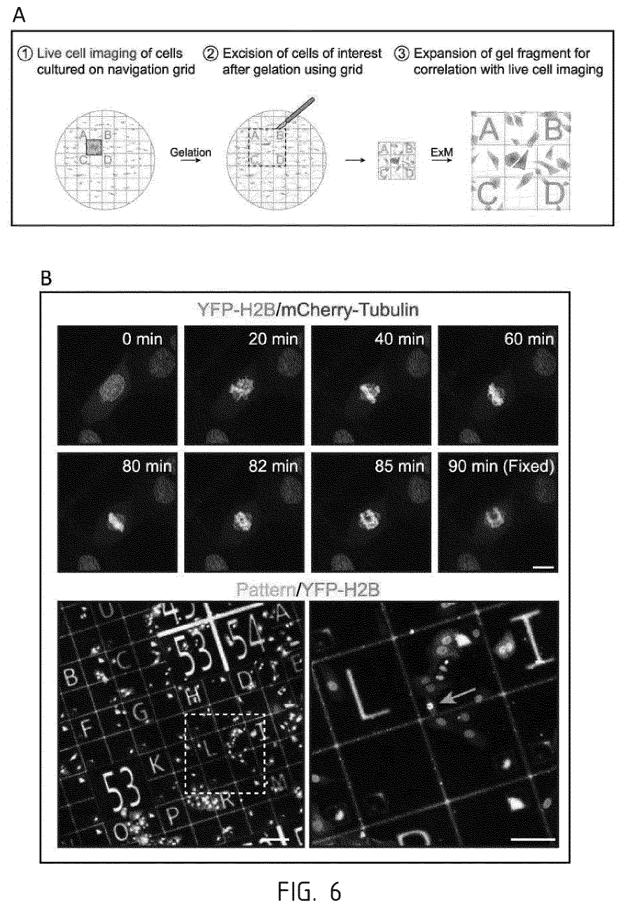

FIG. 6: FIG. 6A shows a schematic 3 step workflow for correlative expansion microscopy; Step (1); cells of interest cultured on patterned coverslip can be followed live to image a dynamic process. Step (2); cells are incorporated into the ExM hydrogel, digested and region of interest as indicated by the pattern excised before expansion. Step (3); gel fragment is expanded, and pattern is used to find back the cell of interest for correlation. FIG. 6B shows a time lapse of a mitotic cell stably expressing YFP-H2B and mCherry-Tubulin that is fixed during anaphase and can be located on the patterned grid. Zooms are indicated by boxed regions. Scale bars: FIG. 6B timelapse 10 μm, below: 200 μm (left) and 100 μm (right).

### EXAMPLES

Quantitative interpretation of expanded samples relies on robust characterization of expansion fidelity, which could be compromised by local anisotropies in expansion due to differences in gel composition, density, or mounting. We reasoned that ExM hydrogels could be intrinsically calibrated by incorporating a scalable fluorescent fiducial pattern, which would allow for precise determination of the local microscopic expansion factor. By generating a culturing surface that contains a fluorescent protein-based pattern of repeating squares (FIGS. 1A, 1), and directly culturing cells on patterned coverslips, we argued both the cells and the pattern would be incorporate into the ExM hydrogel simultaneously (FIGS. 1A, 2). During expansion the pattern expands together with the cells and acts as a scalable ruler to determine the expansion factor. Since the marker is comprised of a repeating grid of known dimensions, local deformations that occur during expansion should be reflected in a visibly distorted grid (FIGS. 1A, 3) that could be used to computationally correct for deformation without relying on a pre-expanded reference state (FIGS. 1A, 4). To test this idea, we set out to develop a scalable fluorescent grid compatible with ExM chemistry that is transferable from culture surface to hydrogel, is protein based so that it is incorporated into the hydrogel simultaneously with the specimen, is customizable, and is biologically inert to ensure biological reproducibility and compatibility with all cell types.

### Reference Grid Assembly and Design

Protein photolithography with deep-UV could be used to generate the fluorescent pattern as it is commonly used for biological applications, including micropatterning, has sufficient spatial resolution to pattern grids with micrometer scale, and is high throughput and easily scalable. We designed various chrome-quartz photomasks to test different numbered grid designs, with repeated features ranging in size from 10 μm to 40 μm to focus on mapping deformations, and larger grid sizes from 200 μm to 400 μm that included markers to aid sample navigation. We tested our patterning approach using coverslips coated with laminin, an extracellular matrix protein (ECM) conjugated to a fluorophore and found we could successfully pattern multiple designs over entire coverslips (FIGS. 1B, 1). Next, we tested whether the fluorescent pattern could be transferred from the culturing substrate to a hydrogel by expanding a region in the middle of the coverslip using Ten-fold Robust Expansion (TREx) microscopy (Damstra et al., 2022, Visualizing cellular and tissue ultrastructure using Ten-fold Robust Expansion Microscopy (TREx). Elife 11:e73775.).

Imaging of the same coverslip after gelation confirmed the pattern is efficiently transferred from the substrate to the hydrogel (FIGS. 1B, 2). When the resulting gel was imaged after moderate expansion (2-3×), we observed local deformations that distorted the uniformity of the pattern and were particularly pronounced near the edge of the gel (FIGS. 1B, 3). By registering the deformed image to the pre-expanded pattern, the deformations could be corrected using non-linear thin plate spline transformation of the deformed image as in (Damstra et al., 2022, Visualizing cellular and tissue ultrastructure using Ten-fold Robust Expansion Microscopy (TREx). Elife 11:e73775.), which restored the uniformity of the pattern in the expanded gel (FIGS. 1B, 4). Finally, we tested whether our approach can directly be used as a culturing substrate by sterilizing the grid and growing cells directly on the protein patterned grid. Following fixation and immunostaining for tubulin and laminin to amplify the fluorescent grid, the sample was imaged pre-expansion and subsequently expanded. Pre-expansion imaging confirmed that cells appear unperturbed by the underlying protein grid and grow indiscriminately of the pattern. Comparison of pre-and post-expansion images confirmed that cells and the pattern are expanded together, and by aligning the expanded image to a virtual reference grid local deformations could be corrected for (FIG. 2).

Using the laminin pattern, we observed intracellular labeling of endogenous laminin when amplifying the pattern. Therefore, we tested patterning efficiency using a different ECM-protein fibrinogen, and a custom nanobody (NBD) that contained an orthogonal myc-tag that could be used for amplification without intracellular background. We found the bulkier ECM proteins patterned as efficiently as the smaller globular nanobody, and in both cases the sterilized patterns could be used as a culturing surface. However, recognizing that some applications of ExM do not require a culturing surface, we reasoned that an approach to create such grid maps within a readily polymerized gel would also carry advantages, including generation of three-dimensional patterned grids. To that end, we introduced the photoactivatable rhodamine into the ExM gelation solution pre-polymerization, and photoactivated a pattern within the gel. Such photoactivated patterns are also stable and expand along with the ExM hydrogel. Together, these results indicate we have developed an easy-to-use, flexible method to intrinsically calibrate ExM hydrogels that is compatible with biological specimen and ExM chemistry.

### Correction of Expansion Anisotropy

Currently, ExM fidelity is often assessed macroscopically, for example for determination of the expansion factor, or locally by quantifying local expansion factor and deformation in a cell of interest. We set out to assess the variability in ExM fidelity. We first wondered how the macroscopic expansion factor, as measured by the size of the expanded gel, relates to the microscopic expansion factor. We expanded patterned grids without cells and compared the microscopic expansion factor of individual squares (2 regions, 849 individual squares, expansion factor 8.9±0.2 (mean±SD)) with 79 individual estimates of macroscopic expansion factor by 7 unbiased participants. This resulted in a 10% (0.82×) variation around the true expansion factor as measured using the grids. We next looked at deformation of individual squares within the same mounted gel by measuring the squareness of individual elements. We could observe regions that appeared hardly deformed, but also more subtle effects that would not necessarily be apparent from looking only at biological structures (FIG. 3A, comparison between region 1 and 2). As expected, we also could observe occasional large local deformations, for example near a tear. We measured the variability in ExM fidelity by quantifying the local expansion factor and squareness for each element within the fields of view (FIG. 3B). Comparison of the deformation of each region with the local expansion factor revealed the spread in expansion factor is similar between both regions of the same gel (approximately 1×). However, we observed a larger spread of squareness for the visibly more deformed region 2 compared to the less deformed region 1 in the same gel, possibly due to sample mounting. Furthermore, across multiple gels and fields of view, we observe a wider variety of deformations. Together, these experiments underscore the need for local quality control mechanisms to standardize quantitative measurements in ExM.

To examine the corrective power of the reference grid assembly of present invention, we wondered how efficient our approach is to correct for deformation on the cellular scale without the need for pre-expansion reference images. To be able to identify the pattern more clearly below the cells, we cultured cells on NBD-patterned coverslip, fixed and stained for tubulin and amplified the pattern using the orthogonal myc-tag. We reasoned that the corrective power would increase as the grid size becomes smaller as small deformations better reflect distortion of the grid, and the number of points that can be used for landmark-based registration to a reference grid increases. To quantify the corrective power, we first defined the total deformation by comparing linear and non-linear transformation of the post-expansion tubulin channel registered to the pre-expansion ground truth tubulin (MT) channel (FIG. 4, uncorrected and MT corrected). Next, we corrected for deformation by registering the pre-and post-expansion pattern channels with landmarks for registration provided by the reference grid followed by non-linear thin plate spline transformation. We overlayed the corrected tubulin image with the pre-expanded ground truth (FIG. 4, pattern (pat.) corrected) which gave a qualitatively comparable corrected image. By comparing linear similarity transformation to non-linear thin plate spline transformation, one can calculate the absolute deformation for equidistantly spaced points (1 μm) within the cellular area (Jurriens D et al., 2020, Methods in Cell Biology. Methods Cell Biol.). The residual error after pattern correction was determined by registering the corrected tubulin channel to the pre-expansion ground truth Indeed, when we compared the absolute error of the uncorrected image with the corrected images, we observed a progressive decrease of the absolute error for correction using landmarks for correction every 30 μm, every 20 μm and every 10 μm with the average absolute error decreasing from 0.76±0.3 (mean±SD) μm without correction to 0.07±0.05 (mean±SD) μm for correction every 10 μm. Next to the number of points used for correction, we noted the absolute improvement in residual error also depends on the initial deformation. We observed that a noticeably less deformed example with average absolute error of 0.29±0.1 (mean±SD) uncorrected was reduced to an average error of 0.07±0.03 (mean±SD) corrected using landmarks every 20 μm.

An alternative measure for deformation is to compare measurement lengths between pairs of points after expansion to the expected distance in the case of uniform expansion and plot the average fractional deviation as a function of the measurement length (Damstra et al., Elife 11, 2022). Again, we observe correction using the grid progressively attenuates the measurement error for a given measurement length. Interestingly, while the uncorrected curve saturates at a measurement length of ~45 μm—with the maximum curvature at ~40 μm—the corrected curves saturate earlier, and shows maximum curvature at ~20 μm, ~10 μm, and 5 μm for correction using landmarks spaced 30 μm, 20 μm and 10 μm, respectively. This is consistent with the hypothesis that correction is more efficient for measurement lengths larger than the distance used for correction. Since our approach is effective in correcting deformations by registering the grid against a pre-expanded reference grid, it consequently implies that the reference grid assembly of present invention can be used to correct deformation using a virtual reference grid, and thus importantly negates the need for a pre-expansion acquisition. Therefore, by intrinsically calibrating the ExM hydrogel with a fluorescent grid that scales with the expansion factor and deforms with anisotropy, we have developed a robust quality control mechanism for ExM.

Grids can be Imprinted onto Tissue Slices During Sample Processing

One of the key advantages of ExM is that it can be used to directly expand tissues and organisms. We reasoned that reference grid assembly of present invention would be compatible with expansion of non-adherent biological samples by incorporating the grid during sample preparation. Gelation is often performed in a gelation chamber that is closed off during polymerization. We therefore expanded mouse brain tissue slices and used a patterned coverslip to close off the gelation chamber, ensuring contact between the tissue slice and the patterned coverslip, thereby imprinting one side of the tissue using (FIG. 5A). Following expansion and staining of the tissue with a NHS general protein stain, we visualized the imprinted fluorescent pattern in combination with the tissue. Strikingly, we could observe significant distortion of the grid indicating local deformations, which we could correct by aligning the expanded image to a virtual reference grid followed by non-linear transformation (FIG. 5B).

We could bridge multiple layers of tissue organization from a low-resolution overview tilescan (1.3×1.2 mm) to a higher resolution overview of the local tissue vasculature (110×110 μm), to high resolution ultrastructural context of brain endothelium and surrounding brain tissue (25×25 μm). Furthermore, from the grid we could extract the exact expansion factor of the tissue, which is essential for precise quantitative measurements, such as synapse separation. Together, we show that the reference grid assembly of present invention is a versatile approach that can be added to various existing ExM sample processing pipelines and provide intrinsic calibration and deformation mapping to expansion of tissue.

### Grid Aids Sample Navigation in Correlative ExM Experiments

Following up live experiments with expansion microscopy is a promising technique that can provide new insight into the nanoscale structures that underly cellular dynamics. However, the sample processing steps required after cell imaging makes it particularly challenging to locate back specific imaged cells in the expanded gels. This is particularly the case for high-expanding gel recipes, as the volume that contains the cell of interest increases with the expansion factor cubed. We reasoned we could again use our approach to pattern a fluorescent coordinate system on coverslips using navigation grids. By culturing cells on reference grids optimally designed for sample navigation, we can follow a process of interest live and locate the cell on the grid (FIGS. 6A, 1), fix and stain the cells for the structure of interest, gelate the sample, and excise the gel region that contains the cell (FIGS. 6A, 2). The excised gel fragment can be expanded, and the grid facilitates correlation of the expanded cell with the cell acquisition (FIGS. 6A, 3). As previously demonstrated, the local deformation and expansion factor can still be determined with this approach.

We designed various navigation grids that could be combined with cultured cells (FIG. 6B). To demonstrate, we cultured cells stably expressing YFP-H2B and mCherry-tubulin on the navigation grid and synchronized the population using thymidine. We picked a cell of interest and followed its progression through mitosis. During anaphase, the cell was rapidly fixed on the microscope stage and located on the navigation grid (FIG. 6B). We next expanded the coverslip using TREx, excised the region of interest relying on navigation provided by the reference grid of present invention and stained for total protein using maleimide. In the expanded sample, we could use the ultrastructural context provided by maleimide to visualize the cell morphology, organelle distribution, and key components of the mitotic spindle, including the spindle midzone, the chromosomes and presumptive kinetochores, and both centrioles on either side of the spindle. Furthermore, by registering the grid to the ground truth we could extract the exact expansion factor for the gel and determine the exact diameter of the centrioles in the cell at 197 nm, consistent with previously reported values.

Altogether we show our approach is a powerful quality control mechanism that can easily be adopted in existing ExM pipelines. Our approach not only allows intrinsic calibration of hydrogel embedded samples, reference-free quantification of expansion factor, and deformation correction, but also aids sample navigation for hydrogel-embedded specimen and is compatible with both cells and tissue.

### CONCLUSION

We developed a reference grid assembly and methods of using this assembly in ExM applications to intrinsically calibrate ExM hydrogels by incorporating a fluorescent grid that scales with the expansion factor and deforms with anisotropy. Our approach solves three key challenges of ExM, First, robust correlation between ground truth and expanded specimens was previously essential for precise determination of the local microscopic expansion factor. The reference grid assembly functions as an expandible ruler of which the ground truth size is known, which intrinsically calibrates the gel and can be used to precisely determine the microscopic expansion factor. Second, correlation between non-expanded and expanded specimen was previously the only way to map local deformations that occur during expansion. Whereas the defined grid enables the user to quantify and correct local deformations without the need for a pre-expanded reference image. Third, reference grid assembly encodes a fluorescent coordinate system to the hydrogel aiding sample navigation of expanded samples. In developing the reference grid assembly, we have established a quality control mechanism that can be incorporated into existing ExM workflows.

Using the reference grid assembly, we could visualize ExM anisotropy along different length scales for multiple gels, including independently mounted regions of the same gel. By quantifying the squareness of individual repeating elements, we found that there can be a significant discrepancy between the true microscopic expansion factor and the macroscopic expansion factor as determined by measuring the expanded gel. Furthermore, within regions of the same gel local deformations can be quite different, potentially due to immobilization of the gel during imaging using poly-L-lysine coated coverslips consistent with previous observations underscoring the need for ExM quality control mechanisms. The reference grid assembly provides an instant readout of the local microscopic expansion factor and local deformation. We have shown that the reference grid assembly can effectively be used to correct for local deformations without the need for reference structures or a pre-expansion acquisition because the patterned grid can be aligned to a virtual reference grid and used for correction.

### MATERIALS AND METHODS

### Photomask Design

CleWin 5 (WieWeb) software was used for design of chrome-quartz photomasks. The following base design was used: 2×2 cm area consisting of 100(00-99) 2×2 mm tiles, containing five 400×400 μm numbers. Variants on the base design followed either a repeated grid pattern for use in mapping gel deformation, or a coordinate letter system to further aid in sample navigation. Photomasks were fabricated by Toppan (Toppan photomasks Germany GmbH), with features (numbers, lines) chrome and blank spaces quartz.

### Protein Conjugation

Fluorescent N-hydroxysuccinimide (NHS)-ester-protein/nanobody conjugation was performed with an 8-fold (Laminin; Roche) or 4-fold (R2-myc-his nanobody; a gift from S. Oliveira) molar excess of fluorescent NHS-ester (Alexa 594, ATTO 647N, Sigma Aldrich, ATTO-TEC GmbH, respectively) in a minimal volume of MQ (ultrapure water). Protein/nanobody and NHS-ester were mixed by vortexing and incubated overnight at 4° C. before storing 10 μg aliquots at −20° C.

### Preparation of Patterned Coverslips

Coverslips (Ø18 mm, #1.5; Marienfeld, 107032) were washed for 10 min in acetone, sonicated for 20 min in 50% methanol and sonicated for a further 20 min in 0.5 M KOH, before washing three times in MQ. Coverslips were then washed in 100% ethanol and dried under a flow of nitrogen before storage. Cleaned coverslips were activated with air plasma (PDC-002, Harrick Plasma) for 1 min before incubation with 2.5 μg fluorescent protein in MQ per coverslip for 1 h at room temperature.

Coverslips were dried at room temperature on a clean tissue for 30 min before being exposed to deep-UV (~250 nm) through a micropatterned chrome/quartz photomask for 4 min, using an UVO cleaner 42-220 (Jelight Company Inc.). Patterned coverslips were washed with PBS for storage at 4° C. Photomasks were cleaned by 10 min acetone and isopropanol alcohol washes, and 20 min exposure to air plasma. Prior to cell seeding, patterned coverslips were sterilized with 70% ethanol and washed three times in sterile PBS. For neuronal experiments, patterned coverslips were top-coated with poly-L-lysine (37.5 μg/ml) and laminin (1.25 μg/ml) in 0.1 M Borate Buffer, pH 8.5. Laminin patterned coverslips were not used for neuronal experiments.

### Photo-Uncageable Rhodamine Patterning in Polymerized Hydrogels

To generate a photoactivatable molecule that could be covalently incorporated into polymerized hydrogels, a two-step conjugation was performed of NVOC2-Q-rhodamine-5-PEG3-azide (Sigma-Aldrich, 768693) to acryloyl-X SE (AcX) (Thermo Fisher, A 20770) using a sulfo-DBCO-amine linker (Broadpharm BP-23309). First, Sulfo-DBCO-amine (40 mM) was reacted with AcX (21 mM) in DMSO for 1 h at RT to form DBCO-AcX. Next, a 2-4× molar excess of NVOC 2-Q-rhodamine-5-PEG3-azide was reacted with DBCO-AcX for 1 h at RT. By homogenously adding the dye to unpolymerized gel solution at a final concentration of 120 μM, the dye is physically linked to the ExM hydrogel after gelation. Using local UV illumination, photoactivated patterns could be generated, expanded with the hydrogel, and used for intrinsic calibration.

### Cell Culture, Plasmids, Optogenetic Repositioning, and Cell Synchronization

U2OS (ATCC) cells were cultured in DMEM medium supplemented with 9% Fetal Bovine Serum and 1% penicillin/streptomycin (GIBCO). Primary hippocampal neurons were maintained in Neurobasal medium supplemented with 1% B27 (GIBCO), 0.5 mM glutamine (GIBCO), 15.6 μM glutamate (Sigma), and 1% penicillin/streptomycin (GIBCO). For imaging of mitosis, U2OS cells expressing YFP-H2B and mCherry-tubulin were synchronized using a double thymidine block, based on (Chen and Deng, Bio-protocol 8, 2018). In short, cells were seeded at 25% confluency, 16 h after seeding cells were incubated with 2 mM thymidine for 24 h, incubated with complete medium for 9 h, blocked again using 2 mM thymidine for 29 h, and released from second block in complete medium 12 h prior to imaging.

### Fixation, Pattern Amplification and Immunostaining

For correlative deformation mapping experiments, cells were extracted using pre-warmed 0.35% Triton X-100+0.2% glutaraldehyde in MRB 80 for 1 min, followed by 4% paraformaldehyde fixation in PBS for 10 min. For experiments using protein stains, cells were fixed with prewarmed (37° C.) 4% paraformaldehyde+0.1% glutaraldehyde+4% sucrose in PBS for 10 min. Next, cells were washed with PBS and permeabilized with PBS+0.2% Triton X-100. Blocking and antibody labeling steps were performed with 3% bovine serum albumin in PBS. The patterned grids were amplified by immunostaining for laminin, or myc-tag (R2-myc-his nanobody) along with antibody labelling for specific structures. The following primary antibodies were used in this work: rabbit anti-laminin (1:100, Abcam ab 11575), rabbit anti-myc-tag (1:100, Cell Signalling Technology 2272), rat anti-tubulin YL1/2(1:200, Abcam ab 6160). The following secondary antibodies were used in this work: goat anti-rabbit IgG Alexa Fluor 594 (Invitrogen A-11037), goat anti-rat IgG Alexa Fluor 488 (Invitrogen A-11006), all at a 1:250 dilution.

### Tissue Fixation and Sectioning

All animal experiments were carried out according to the regulations of Utrecht University and in agreement with Dutch law (Wet op de Dierproeven, 1996) and European regulations (Directive 2010/63/EU). 10-month-old, TRAP2 mice were transcardially perfused with ice-cold fixative solution (4% formaldehyde and 20% acrylamide in PBS, pH 7.4). Brains were removed and post-fixed in fixative solution overnight at 4° C. Fixed brains were washed three times for one hour in PBS at RT and cut coronally into 100 μm thick sections using a vibratome (Leica VT 1000 S). After cutting, fixed brain sections were stored in PBS at 4° C.

### Tenfold Robust Expansion (TREx) Microscopy

Tenfold Robust Expansion (TREx) microscopy was performed according to (Damstra et al., Elife 11, 2022). In short, cells were treated with 100 μg/mL acryloyl-X SE (AcX) (Thermo Fisher, A20770) in PBS overnight at RT. TREx gelation solution was prepared containing 1.1 M sodium acrylate, 2.0 M acrylamide (AA), 50 ppm N,N′-methylenebisacrylamide (bis), PBS (1×), 0.15% APS, 0.15% TEMED. Gels were prepared in a gelation chamber consisting of a parafilm covered glass slide with a silicone gasket (Sigma-Aldrich, GBL 66410). Gels were left to gelate for 1 h at 37° C. Next, samples were transferred to a 12-well plate and digested with 7.5 U/mL Proteinase-K (Thermo Fisher, EO0491) in TAE buffer (containing 40 mM Tris, 20 mM acetic acid and 1 mM EDTA) supplemented with 0.5% Triton X-100, 0.8 M guanidine-HCl, and DAPI for 4 hours at 37°C. For correlative experiments, regions of interest were located after digestion using fluorescent grid, excised, and expanded using an EVOS imaging system equipped with Plan Fluor 10×/0.3 objective (ThermoFisher Scientific). The gel was transferred to a Petri dish, water was exchanged 2×30 minutes and the sample was left in MQ to expand overnight. Prior to imaging the cells were trimmed using a scalpel blade to fit in a Attofluor Cell Chamber (Molecular probes A-7816), or a custom designed 3D printed imaging chamber.

For samples stained for total protein using maleimide, gels were washed 2×15 min in PBS after gelation and incubated with 20 μg/mL Atto 647N maleimide (Atto-Tec, AD 647N) in PBS prepared from a 20 mg/mL stock solution in DMSO for 1.5 hour at RT with shaking. Next, samples were rinsed in PBS, digested, and expanded as described above.

### Expansion of Tissue and Incorporating Patterned Grids During Sample Processing

For expansion of tissue, brain slices were pre-incubated with TREx gelation solution with 15μg/mL 4-hydroxy-TEMPO added to delay premature gelation for 30 minutes on ice. To create the gelation chamber, tissue slices were laid out on a microscopy slide with 4 dabs of vacuum grease surrounding the slice. A patterned coverslips was placed with the protein grid facing the tissue on top of the dabs of vacuum grease and pressed down ensuring contact with the tissue slice. The gelation chamber was filled with gelation solution from the side and transferred to 37° C. for 1 h. After gelation, the gel surrounding the tissue was trimmed and the sample was disrupted for 3 h at 80° C. in disruption buffer containing 5% SDS, 200 mM NaCl, and 50 mM Tris pH 7.4. After disruption, gels were washed in PBS and stained with 30 μg/mL NHS-ester conjugated to ATTO488 (ATTO-TEC GmbH) for 2 h at RT. After staining, gels were washed and expanded in MQ. Prior to imaging the cells were trimmed using a scalpel blade to fit in a Attofluor Cell Chamber (Molecular probes A-7816), or a custom designed 3D printed imaging chamber.

### Imaging Acquisition and Analysis

ExM and pre-expansion images were acquired using a Leica TCS SP8 STED 3× microscope equipped with HC PL APO 20×/0.75 dry and HC PL APO 86×/1.20 W motCORR STED (Leica 15506333) water objectives. A pulsed white laser (80 MHz) and a 405 nm DMOD Flexible UV laser were used for excitation. The internal Leica GaAsP HyD hybrid detectors were used with a time gate of 1≤tg≤6 ns. The set-up was controlled using LAS X. For photo-uncaging of rhodamine to create patterns in polymerized hydrogel, 50×50 μm field of views were scanned withof 405 nm laser light to create a boxed pattern.

For imaging of pre-expanded neurons cultured on patterned coverslips, a Zeiss LSM 700 confocal setup consisting of an AxioObserver Z1 microscope with a Plan-Apochromat 20×/0.8 dry objective was used. The set-up was controlled using ZEN.

For live-cell imaging of mitosis, coverslips were mounted in complete medium and images acquired using a 60× (Plan Apo VC, NA 1.4; Nikon) oil-immersion objective on a Spinning Disc (Yokogawa CSU-X1-A1) Nikon Eclipse Ti microscope with Perfect Focus System equipped with a sample incubator (Tokai-Hit) and an Evolve 512 EMCCD camera (Photometrics), controlled with MetaMorph 7.7 software (Molecular Devices). Cobolt Calypso 491 nm and Cobolt Jive 561 nm lasers were used for excitation. Images were acquired every 60 s and fixed on the stage during imaging with pre-warmed fixative. All imaging processing was done using FIJI. For non-linear transformation of post-expanded images using landmark-based registration of expanded samples to the (virtual) reference grid the plugin BigWarp was used (Bogovic, J. A., et al., 2016, Robust registration of calcium images by learned contrast synthesis. In 2016 IEEE 13th International Symposium on Biomedical Imaging (ISBI)). To quantify the corrective power of the reference grid, the absolute error for equidistantly spaced points in the cellular volume and the measurement error for a given measurement length were calculated according to (Jurriens et al., Methods in Cell Biology. Methods Cell Biol.) and (Damstra et al., 2022, Elife), respectively. Expansion anisotropy was quantified using a semi-automatic ‘squareness’ measurement of deformation. This measure was defined by the detection of the square corners for each square in the reference grid, and the averaging of two metrics: the ratio of the lengths of the diagonals, and the ratio of the intersection angles of the diagonals. A value of 1 will only be obtained with a perfect square, taking into account both stretching and skewness.

1. A reference grid assembly for use in expansion microscopy (ExM) of a biological sample, wherein the reference grid assembly comprises an expandible hydrogel or a substrate suitable for cell culture, wherein said hydrogel or substrate comprises a micropattern comprising micropatterned photoreactive or photoactivatable organic molecules or peptides providing a scalable and expandible calibration marker for ExM.

2. The reference grid assembly according to claim 1, wherein the micropatterned photoreactive or photoactivatable organic molecules or peptides are engineered peptides comprising one or more sites for fluorophore labelling and/or acrylate modification.

3. The reference grid assembly according to claim 1, wherein the micropattern is comprised of a continuous repeated pattern.

4. The reference grid assembly according to claim 1, wherein the micropattern is comprised of a continuous repeated square pattern, preferably wherein the square pattern is comprised of squares having a size of 250×250 nm to 250×250 μm, preferably 500×500 nm to 100×100 μm, more preferably 1×1 μm to 50×50 μm, most preferably 10×10 μm to 30×30 μm.

5. The reference grid assembly according to claim 1, wherein the micropattern is furthermore comprised of one or more different micropattern designs, such as letters, numbers or geometric shapes, having a size in length of about 1 to 400 μm, preferably 5 to 250 μm, more preferably 10 to 100 μm.

6. The reference grid assembly according to claim 1, wherein the micropatterned photoreactive or photoactivatable organic molecules or peptides are one or more selected from the group consisting of photoreactive or photoactivatable labeled matrix proteins such laminin, fibrinogen, and photoreactive or photoactivatable labeled nanobodies, preferably photoreactive or photoactivatable labeled nanobodies.

7. The reference grid assembly according to claim 1, wherein the micropatterned photoreactive or photoactivatable organic molecules or peptides are conjugated with a photoreactive or photoactivatable agent selected from the group consisting of a fluorophore such as a photoactivatable fluorophore, a photoactivatable rhodamine (NVOC2-Q-rhodamine), fluorescent dye, fluorescent protein, and photoconvertible dyes.

8. The reference grid assembly according to claim 1, wherein the micropatterned photoreactive or photoactivatable organic molecules or peptides are biologically inert in respect to the biological sample to be used in ExM.

9. The reference grid assembly according to claim 1, wherein the micropatterned photoreactive or photoactivatable organic molecules or peptides are furthermore labelled by fluorescent antibodies.

10. The reference grid assembly according to any claim 1, wherein the substrate is a coverslip, preferably a glass, polyacrylamide or polydimethylsiloxane coverslip.

11. The reference grid assembly according to claim 1, wherein said substrate is furthermore comprised of a top coating comprised of poly-L-lysine, poly-D-lysine, extracellular matrix protein such as laminin or fibrinogen.

12. (canceled) (ExM)

13. (canceled)

14. Method according to claim 21, wherein the method further comprises the step of f) or e), respectively, quantitative interpretation of the expanded biological sample by determination of the expansion factor and deformation mapping using the reference grid.

15. The method according to claim 21, wherein the method furthermore comprises the step of contacting the micropatterned photoreactive or photoactivatable proteins with fluorescent antibodies providing further signal amplification of the micropatterned photoreactive or photoactivatable proteins.

16. The method according to claim 21, wherein micropatterning is done using deep UV or by laser, for example protein photolithography with deep-UV.

17. The method according to claim 22, wherein the culturing substrate comprised of the reference grid is sterilized before application of the biological sample on said culturing substrate.

18. The method according to claim 21, wherein the substrate is a coverslip, preferably a glass, polyacrylamide or polydimethylsiloxane coverslip.

19. The method according to claim 21-18, wherein said substrate is furthermore provided with a top coat, wherein the topcoat is comprised of poly-L-lysine and/or laminin.

20. (canceled)

21. A method for analyzing a biological sample by expansion microscopy (ExM) comprising:
a) incorporating a biological sample in a reference grid assembly, the reference grid assembly comprising an expandible hydrogel or a substrate suitable for cell culture, wherein said hydrogel or substrate comprises a micropattern comprising micropatterned photoreactive or photoactivatable organic molecules or peptides providing a scalable and expandible calibration marker for ExM,
b) expansion of said hydrogel including the biological sample and the reference grid by addition of an aqueous solution to the polymerized hydrogel,
c) observing the expanded biological sample under a microscope.

22. The method according to claim 21, wherein incorporating the biological sample in the reference grid assembly comprises:
a1) providing a substrate suitable for cell culture, such as a cover slip, that is micropatterned with photoreactive or photoactivatable organic molecules or peptides, thereby providing a reference grid to said substrate,
a2) contacting the biological sample, such as tissue or cells, with the substrate thereby providing the biological sample with the reference grid
a3) transfer of the biological sample comprising the reference grid to an unpolymerized hydrogel solution suitable for ExM, followed by polymerization of the hydrogel including the biological sample and the reference grid.

23. The method according to claim 21, wherein incorporating the biological sample in the reference grid assembly comprises:
a1) providing a biological sample in an unpolymerized hydrogel solution suitable for ExM comprised of photoreactive or photoactivatable organic molecules or peptides that can be micropatterned, followed by polymerization of said hydrogel including the biological sample,
a2) micropatterning of the photoreactive or photoactivatable organic molecules or peptides in the polymerized hydrogel, thereby providing a reference grid in the polymerized hydrogel.
